(19) United States
(12) Patent Application Publication
(10) Pub. No.: US 2017/0271975 A1
(43) Pub. Date: Sep. 21, 2017

(54) TEMPORARY ENERGY STORAGE FOR VOLTAGE SUPPLY INTERRUPTIONS

(71) Applicant: SEMICONDUCTOR COMPONENTS INDUSTRIES, LLC, Phoenix, AZ (US)

(72) Inventor: Jan PLOJHAR, Mokra-Horakov (CZ)

(73) Assignee: SEMICONDUCTOR COMPONENTS INDUSTRIES, LLC, Phoenix, AZ (US)

(21) Appl. No.: 15/174,758

(22) Filed: Jun. 6, 2016

Related U.S. Application Data
(60) Provisional application No. 62/308,515, filed on Mar. 15, 2016.

(51) Int. Cl. H02M 1/32; H02H 9/04; H02M 7/06

(52) U.S. Cl. CPC H02M 1/32; H02M 7/06; H02H 9/045

(57) ABSTRACT

In one form, a capacitor voltage limiter (240), comprises a supply node (244), a pass element (242) having a first current electrode coupled to the supply node (244), a control electrode, and a second current electrode. The second current electrode is adapted to be coupled to an external storage capacitor (250). Additionally, the capacitor voltage limiter includes an amplifier having a non-inverting input for receiving a reference voltage, and an inverting input coupled to the second current electrode of the pass element (242). The amplifier includes an output coupled to the control electrode of the pass element (242). The capacitor voltage limiter also includes a rectifier (241) having an input coupled to the second current electrode of the pass element (242), and an output coupled to the first current electrode of the pass element (242).

### CROSS-REFERENCE TO RELATED APPLICATION(S)

This application claims priority to U.S. Provisional Application No. 62/308515, filed on Mar. 15, 2016, entitled “Temporary Energy Storage for Voltage Supply Interruptions,” invented by Jan Plojhar, and is incorporated herein by reference and priority thereto for common subject matter is hereby claimed.

### FIELD OF THE DISCLOSURE

The present disclosure relates generally to electrical and electronic circuits, and more particularly to backup energy storage systems.

### BACKGROUND

Automotive applications have become increasingly dependent on the use of electronic modules. From the need to increase safety features, to the ongoing push towards vehicle electrification and autonomous driving, the requirement for dependable electronic modules is critical. Vehicles of every facet (e.g. motor vehicles, hybrid electric vehicles, electric vehicles, aircraft, etc) require many electronic modules. These modules provide essential features that must continue working even when an energy supply source is temporarily interrupted. Interruptions, due to disturbances in the vehicle power network, could cause travel complications and potentially irreversible damage in the case of vehicles that are highly dependent on a fully operational electronic network.

Electronic modules, also described as electronic controllers, utilized in automotive vehicles, aircrafts, and similar environments, frequently experience large voltage overshoots and deep under voltage interruptions. Currently, one way to manage power interruptions is with the use of a buffer capacitor. Buffer capacitors are typically connected between the device's input (power supply) and output (load). The most common approach is to place a buffer capacitor after a reverse current blocking element (e.g. a diode). The reverse current blocking element prevents the capacitor from discharging into the input power supply when the voltage at the input power supply is interrupted (i.e. drops below a predetermined voltage level). This backup energy storage architecture has several drawbacks. The capacitance must be large enough to maintain a charge sufficient to keep any intermediate voltage above the minimum input voltage of a downstream component, such as a voltage regulator. The capacitance requirement within this architecture may result in a very bulky capacitor, resulting in an expensive module. Another drawback to this backup energy storage architecture occurs during overvoltage conditions, such as during a “load dump” or “jump start” of a component connected to the voltage limiter. During an overvoltage condition, the capacitor is directly exposed to possible overvoltage. Therefore, in order to maintain the reliability of the circuit, and any connected components, the capacitor must have a voltage rating sufficient to handle the potential overvoltage resulting from the load dump.

The combination of the requirements for a high voltage rating and a large capacitance in this backup energy storage architecture increases the size and cost of the module.

### BRIEF DESCRIPTION OF THE DRAWINGS

The present disclosure may be better understood, and its numerous features and advantages made apparent to those skilled in the art by referencing the accompanying drawings, in which:

FIG. 1 illustrates in block diagram form a power supply system with backup energy storage according to one embodiment;

FIG. 2 illustrates in partial block diagram form and partial schematic form a power supply system that implements the apparatus of FIG. 1;

FIG. 3 illustrates a timing diagram depicting the operations of the power supply system of FIG. 2; and

FIG. 4 illustrates a flow diagram of a method for providing a power supply with backup energy storage according to an embodiment.

The use of the same reference symbols in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION

For simplicity and clarity of the illustration, elements in the figures are not necessarily to scale, are only schematic, and are non-limiting. Additionally, descriptions and details of well-known steps and elements are omitted for simplicity of the description. It will be appreciated by those skilled in the art that the words “during”, “while”, and “when” as used herein relating to circuit operation are not exact terms that mean an action takes place instantly upon an initiating action but that there may be some small but reasonable delay, such as a propagation delay, between the reaction that is initiated by the initial action. Additionally, the term “while” means that a certain action occurs at least within some portion of a duration of the initiating action. The use of the word “approximately” or “substantially” means that a value of an element has a parameter that is expected to be close to a stated value or position. However, as is well known in the art there may be minor variances that may prevent the values or positions from being exactly as stated.

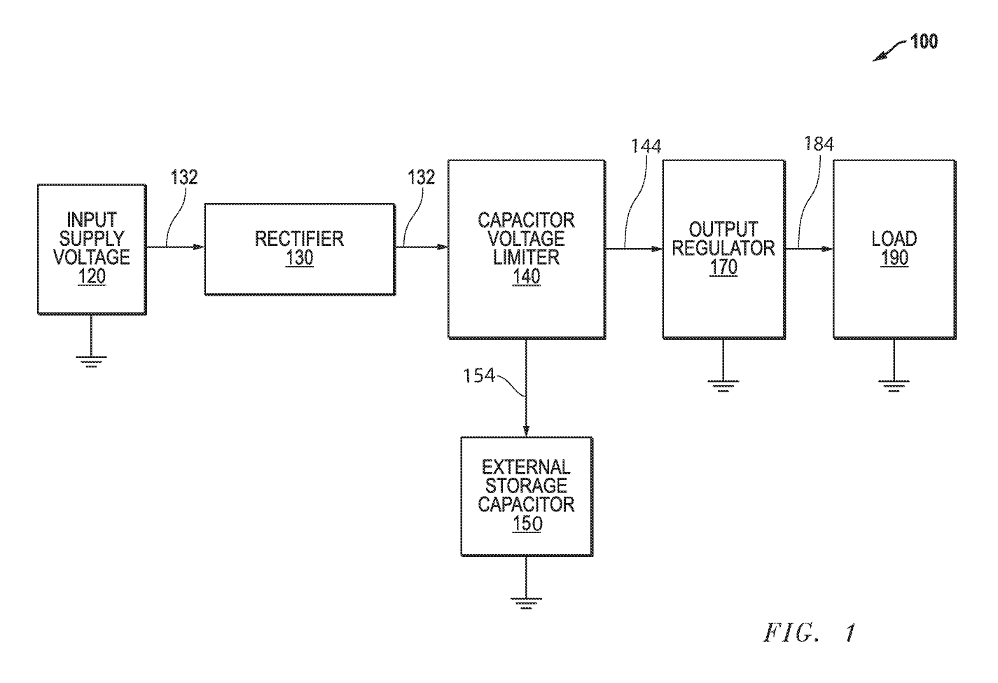

FIG. 1 illustrates in block diagram form a power supply system 100 with backup energy storage according to one embodiment. The example power supply system 100 in FIG. 1 includes a variable input supply voltage source 120, a rectifier 130, a conductor 132, a capacitor voltage limiter 140, an external storage capacitor 150, an output regulator 170, and a load 190. Rectifier 130 has a first electrode connected to input supply voltage source 120, and a second electrode connected to capacitor voltage limiter 140. Capacitor voltage limiter 140 is connected to external storage capacitor 150. Output regulator 170 has a first terminal (input electrode) connected to capacitor voltage limiter 140 via a supply node. A load, such as load 190, connects to a second terminal (output electrode) of output regulator 170.

Input supply voltage source 120 has an output for providing an input voltage. Rectifier 130 has a first electrode connected to the output of input supply voltage source 120, and an output. Capacitor voltage limiter 140 has an input connected to the output of rectifier 130, and an output for connecting to the first terminal of external storage capacitor 150. Capacitor voltage limiter 140 provides a voltage to the first terminal of external storage capacitor 150 that is limited to a predetermined voltage. Additionally, capacitor voltage limiter 140 has an output for connecting to an output regulator and/or a load. In this embodiment, capacitor voltage limiter 140 has an output connected to the input of output regulator 170. Output regulator 170 has an output for providing voltage to the input of load 190.

In the illustrated embodiment, input supply voltage source 120 normally supplies power to load 190. External storage capacitor 150 is separated from input supply voltage source 120 by capacitor voltage limiter 140. When input supply voltage source 120 supplies a sufficiently large voltage, capacitor voltage limiter 140 also charges external storage capacitor 150 from input supply voltage source 120 up to a predetermined voltage limit. The charge of external storage capacitor 150 is defined by the operations of capacitor voltage limiter 140. A rectified voltage, transmitted via conductor 132, is received at capacitor voltage limiter 140. Capacitor voltage limiter 140 regulates the voltage received across external storage capacitor 150. Capacitor voltage limiter 140 discontinues charging external storage capacitor 150 when the voltage across external storage capacitor 150 reaches the predetermined voltage limit, as determined by the operations and components of capacitor voltage limiter 140.

In another embodiment, capacitor voltage limiter 140 has a predetermined in-rush current limit. The predetermined in-rush current limit enables fast charging of external storage capacitor 150 while preventing excessive currents during startup.

External storage capacitor 150 supplies power to load 190 during power supply interruptions. When input supply voltage source 120 is interrupted, or its voltage drops below a predetermined voltage, power supply system 100 switches to utilizing external storage capacitor 150 as a power source for load 190. Capacitor voltage limiter 140 allows load current to be conducted from the first terminal of external storage capacitor 150 into load 190, while rectifier 130 prevents the flow of current from external storage capacitor 150 into input supply voltage source 120. In this manner, the output voltage to load 190 remains substantially constant while the voltage rating of external storage capacitor 150 can be made relatively small, thereby reducing its cost.

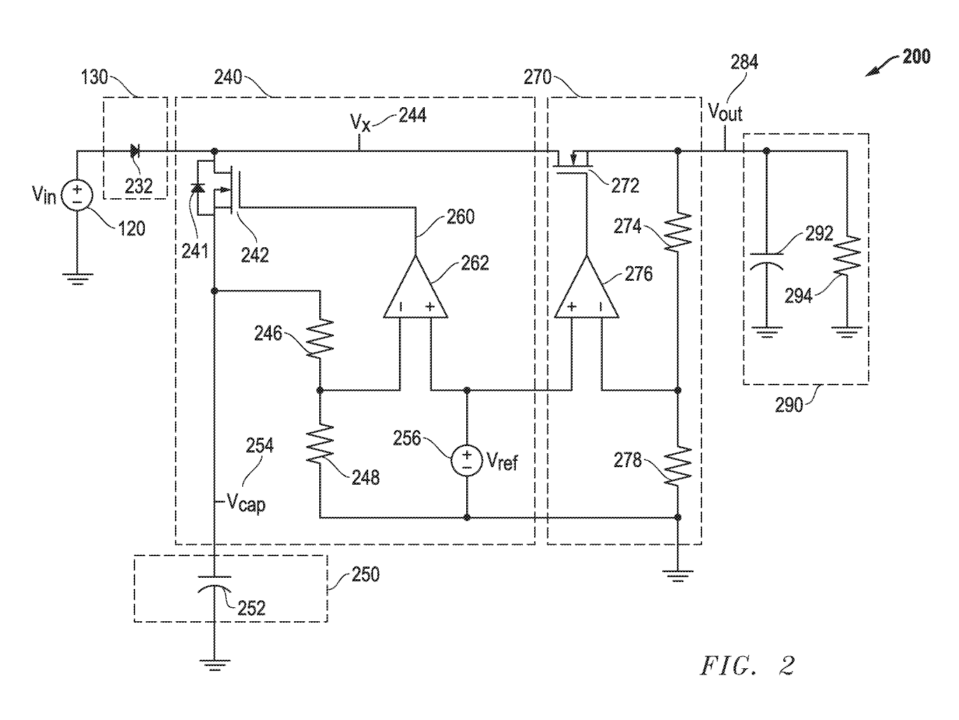

FIG. 2 illustrates in partial block diagram and partial schematic form a power supply system 200 that implements the apparatus of claim 1. Power supply system 200 includes generally a voltage source 120, a rectifier 130, a capacitor voltage limiter 240, an external storage component 250, a voltage regulator 270, and a load 280.

Voltage source 120 has a positive terminal for providing an input supply voltage, and a negative terminal connected to ground. Input supply voltage source 120 may be, for example, a battery and in automotive applications, a car battery that is subject to output voltage fluctuations, interruptions, and periodic recharging.

Rectifier 130 has an input terminal connected to the output terminal of input supply voltage source 120, and a second terminal connected to a supply node 244 conducting a voltage labeled “Vx”. In the embodiment illustrated in FIG. 2, rectifier 230 is implemented with a PN junction diode, but in other embodiments it may be implemented with various other known passive and active rectifiers.

Capacitor voltage limiter 240 has a first terminal connected to supply node 244, a second terminal connected to a node 254 that conducts a voltage labeled “Vcap”, and a third terminal connected to ground. Capacitor voltage limiter 240 includes a pass element in the form of an N-channel transistor 242, a resistor 246, a resistor 248, a voltage source 256, and a differential amplifier 262. Transistor 242 has a first drain electrode connected to supply node 244, a gate, and a second source electrode. Associated with transistor 242 is a diode 241 having an anode connected to the second source terminal of transistor 242, and a cathode formed in the first drain terminal of transistor 242. The anode is formed by providing a local connection between the second source terminal of transistor 242 and the body of transistor 242. The PN junction is formed between the P− body and the N+ first drain terminal of transistor 242, which functions as the cathode of diode 241. Resistor 246 has a first terminal connected to the second source terminal of transistor 242, and a second terminal. Resistor 248 has a first terminal connected to the second terminal of resistor 246, and a second terminal connected to ground. Voltage source 256 has a positive terminal and a negative terminal connected to ground. Differential amplifier 262 has a non-inverting input connected to the positive output of voltage source 256, an inverting input connected to the second terminal of resistor 246, and an output connected to the gate of transistor 242.

External storage capacitor 250 includes an electrolytic capacitor 252 which has a first terminal connected to node 254, and a second terminal connected to ground. Electrolytic capacitor 252 is designated as being external because it has a voltage and voltage rating not suitable for integration, whereas capacitor voltage limiter 240 is suitable for integration.

Voltage regulator 270 includes a pass element in the form of an N-channel transistor 272, a resistor 274, a resistor 278, and a differential amplifier 276. Transistor 272 has a first drain electrode connected to supply node 244, a gate, and a second source electrode. Resistor 274 has a first terminal connected to node 284 and to the second source terminal of transistor 272, and a second terminal. Resistor 278 has a first terminal connected to the second terminal of resistor 274, and a second terminal connected to ground. Differential amplifier 276 has a non-inverting input connected to the positive output of voltage source 256, an inverting input connected to the first terminal of resistor 278, and an output connected to the gate of transistor 272.

Load 290 includes a capacitor 292 and a resistor 294. Capacitor 292 has a first terminal connected to node 284, and a second terminal connected to ground. Resistor 294 has a first terminal connected to the first terminal of capacitor 292, as well as node 284, and a second terminal connected to ground.

In operation, input supply voltage source 120 and voltage source 256 (Vref), of power supply system 200, are connected. The voltage at supply node 244 (Vx), is equivalent to the input voltage (Vin) minus the value of the cut-in voltage of diode 232. When the value of voltage source 256 is greater than the voltage value conducted at node 254 (Vcap) through the resister divider, differential amplifier 262 makes transistor 242 conductive. The voltage at node 254 increases as electrolytic capacitor 252 is charged by input supply voltage source 120. Differential amplifier 262 continues to keep transistor 242 conductive while Vcap increases, until the voltage on node 254 through the resistor divider is approximately equivalent to voltage source 256. When the voltage on node 254 is approximately equal to voltage source 256, differential amplifier 262 makes transistor 242 non-conductive, therefore limiting further static current from flowing into electrolytic capacitor 252. Input supply voltage source 120 decreases during use as its energy is drained by load 290. When the voltage at supply node 244 is less than the voltage at node 254, less the cut-in-voltage of diode 232, electrolytic capacitor 252 starts supplying current to load 290 through diode 241 and transistor 242. Vcap continues to supply current into load 290 until electrolytic capacitor 252 discharges, or a new battery is connected. When the current drawn by load 290 causes the voltage at node 254 to drop such that the voltage at node 254, is less than Vref, then differential amplifier 262 again makes transistor 242 conductive; thereby, enabling input supply voltage source 120 to recharge electrolytic capacitor 252.

Power supply system 200 utilizes capacitor voltage limiter 240 to limit the voltage across electrolytic capacitor 252 as voltage source 120 charges electrolytic capacitor 252. Once electrolytic capacitor 252 is fully charged, capacitor voltage limiter 240 restricts additional current flow to electrolytic capacitor 252. When input supply voltage source 120 experiences an interruption or undervoltage, capacitor voltage limiter 240 enables electrolytic capacitor 252 to dynamically supply energy to load 290.

In power supply system 200 of FIG. 2, transistor 242 is an N-channel metal-oxide-semiconductor (MOS) field effect transistor (FET); however, transistor 242 could be implemented with other types of pass elements. For example, in one embodiment transistor 242 could be a P-channel MOSFET. In which case the P-channel transistor 242, has a first source electrode connected to supply node 244, a gate, and a second drain electrode. Associated with transistor 242 is diode 241 having a cathode connected to the first source terminal of transistor 242, and an anode formed in the second drain terminal of transistor 242. The anode is formed by providing a local connection between the second drain terminal of transistor 242 and the body of transistor 242. The PN junction is formed between the N− body and the P+ first source terminal of transistor 242, which functions as the cathode of diode 241.

In another embodiment, capacitor voltage limiter 240 utilizes alternate components to limit the voltage across electrolytic capacitor 252. Transistor 242, of capacitor voltage limiter 240, may comprise a junction field effect transistor (JFET). When a JFET, or an equivalent thereof, is utilized as transistor 242, feedback from differential amplifier 262 is optional. Given, for this example, the JFET is an N-type device, the first electrode terminal of transistor 242 is connected to supply node 244, the second electrode terminal of transistor 242 is connected to capacitor 252, and the control, or gate electrode terminal of transistor 242 is connected to ground. Capacitor 252 charges until the voltage at the second electrode of transistor 242 reaches a predetermined voltage, as defined by transistor 242 cutoff voltage (Vgs). When Vgs is reached, the current flowing to capacitor 252 is stopped due to transistor 242 turning off. Additionally, transistor 242 can be a bipolar junction transistor (BJT), silicon controlled rectifier (SCR), or equivalents thereof.

Rectifier 130 could be implemented with other types of passive rectifiers or with synchronous rectifiers. In one embodiment, power supply system 200 can include a regulator, a combination of regulators, or no regulator at all. Voltage regulator 270, of power supply system 200, can comprise any component or a combination of components that enable regulation of the voltage supply to load 290. For example, a combination of a charge-pump regulator and a downstream regulator utilizing a series PMOS pass element may be implemented as regulator 270. Alternatively, power supply system 200 does not require a regulator. When the unregulated voltage is sufficient to power load 290, power supply system 200 provides an unregulated Vx to load 290 via supply node 244.

In one embodiment, the functions of capacitor voltage limiter 240, voltage regulator 270, and load 290 are provided on an integrated circuit configured in one of a first configuration, a second configuration, and a third configuration, or a combination thereof. The first architecture, or configuration, comprises capacitor voltage limiter 240 and voltage regulator 270 combined on a single integrated circuit. The second configuration comprises capacitor voltage limiter 240, regulator 270, and load 290 combined on the single integrated circuit. The third configuration comprises capacitor voltage limiter 240 and regulator 270, combined to function as the load.

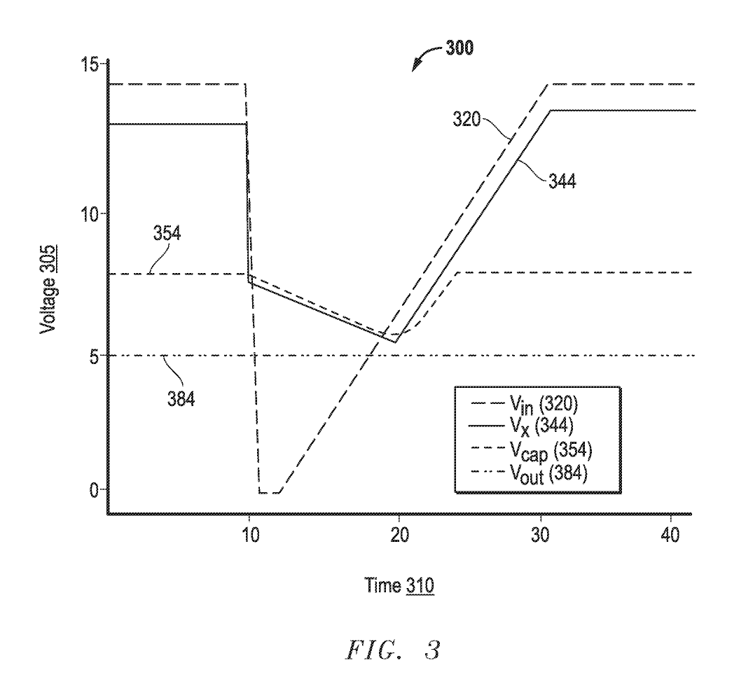

FIG. 3 illustrates timing diagram 300, depicting the operations of power supply system 200 of FIG. 2. Within timing diagram 300, voltage 305 (x-axis) is plotted against time 310 (y-axis). Shown in timing diagram 300 are a waveform 320 of input voltage (Vin), a waveform 344 of supply node voltage (Vx), a waveform 354 of the voltage at the first terminal of the external capacitor (Vcap), and a waveform 384 of the output voltage (Vout). With respect to FIG. 2, Vin 320 is the measurement for input supply voltage source 120, Vx 344 is equivalent to the measurement at supply node 244, Vcap 384 is the voltage measurement at the node of the first terminal of electrolytic capacitor 252, and Vout 384, the voltage received by the load, is the voltage at node 284 of FIG. 2. The values and units of voltage 305 and time 310 are arbitrary.

FIG. 3 depicts the operations of the power supply system of FIG. 2; therefore FIG. 3 will be described with respect to the operations of power supply system 200. Input supply voltage source 120 initially powers the load. Vx is approximately equal to Vin minus the value of the cut-in voltage of diode 232. When Vref is greater than the voltage at the second terminal of resistor 246, differential amplifier 262 makes transistor 242 more conductive. Vcap increases as input supply voltage source 120 charges electrolytic capacitor 252. Differential amplifier 262 increases the conductivity of transistor 242 until the voltage conducted at Vcap 354 (through the resistor divider) is approximately equal to Vref. When the voltage at the second terminal of resistor 246 is approximately equal to Vref, differential amplifier 262 makes transistor 242 non-conductive, therefore limiting further static current from flowing into electrolytic capacitor 252 and limiting the voltage across electrolytic capacitor 252. Vin typically decreases during use as the energy stored in input supply voltage source 120 is drained by load 290. When Vx decreases below Vcap, less the cut-in-voltage of diode 241, electrolytic capacitor 252 starts supplying current to load 290 through diode 241. When the current drawn by load 290 causes Vcap to drop such that the voltage at the second terminal of resistor 246 is less than Vref, then differential amplifier 262 again makes transistor 242 conductive enabling Vin 320 to recharge electrolytic capacitor 252, Electrolytic capacitor 252 continues to supply current into load 290 until electrolytic capacitor 252 discharges, or Vin returns. If Vin returns, then amplifier 262 keeps transistor 242 conductive until the voltage at the second terminal of resistor 246 again equals Vref. As depicted by timing diagram 300, power supply system 200 continuously provides Vout at a sufficient level to load 290, preventing circuit failure during an interruption of Vin.

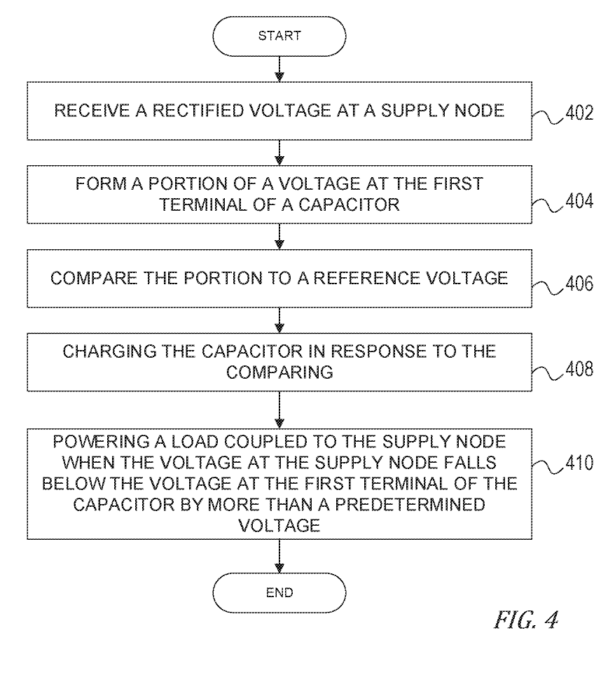

FIG. 4 illustrates a flow diagram of method 400 for providing a power supply with backup energy storage. At block 402 a rectified voltage is received at a supply node. A portion of a voltage at the first terminal of an external storage capacitor is formed at block 404. At block 406, this portion is compared to a reference voltage. In response to the comparing, the external storage capacitor is charged at block 408. At block 410, a second current is conducted from the first terminal of the capacitor to the supply node when a supply node voltage falls below the voltage detected at the first terminal of the external capacitor by more than a predetermined voltage. The process concludes at the end block.

While the subject matter of the invention is described with specific preferred embodiments and example embodiments, the foregoing drawings and descriptions thereof depict only typical embodiments of the subject matter and are not therefore to be considered as limiting of its scope, and many alternatives and variations will be apparent to those skilled in the art. Inventive aspects of the present disclosure may lie in less than all features of a single foregoing disclosed embodiment. As just one example, while FIG. 2 illustrates one embodiment of a capacitor voltage limiter, other types of voltage limiter circuits can be used to limit voltage to an energy storage capacitor, including voltage limiters with varying pass element architectures.

Furthermore, some embodiments described herein include some but not other features included in other embodiments, and therefore combinations of features of different embodiments are meant to be within the scope of the disclosure, and form different embodiments, as would be understood by those skilled in the art.

1. A capacitor voltage limiter (240), comprising:
a supply node;
a pass element having a first current electrode coupled to the supply node, a control electrode, and a second current electrode adapted to be coupled to an external storage capacitor; and
an amplifier having a non-inverting input for receiving a reference voltage, an inverting input coupled to the second current electrode of the pass element, and an output coupled to the control electrode of the pass element; and
a rectifier having an input coupled to the second current electrode of the pass element, and an output coupled to the first current electrode of the pass element.

2. The capacitor voltage limiter of claim 1, wherein the rectifier comprises a PN junction diode.

3. The capacitor voltage limiter of claim 2, wherein:
the pass element comprises a metal-oxide-semiconductor (MOS) transistor;
the second current electrode of the pass element is coupled to a body thereof; and
the PN junction diode is a parasitic diode between the body and the first current electrode of the MOS transistor.

4. The capacitor voltage limiter of claim 3, wherein the MOS transistor comprises a P-channel MOS transistor.

5. The capacitor voltage limiter of claim 1, wherein the inverting input of the amplifier is coupled to the second current electrode of the pass element through a resistor divider.

6. The capacitor voltage limiter of claim 1, wherein the supply node is coupled to a first integrated circuit terminal, and the first current electrode of the pass element is coupled to a second integrated circuit terminal.

7. A power supply system for delivering power to a load, comprising:
a first rectifier having an input terminal adapted to receive a variable voltage, and an output terminal; and
a capacitor voltage limiter for temporary energy storage, comprising:
a pass element having a first current electrode coupled to the output terminal of the first rectifier, a control electrode, and a second current electrode adapted to be coupled to a storage capacitor;
a second rectifier having an input terminal coupled to the second current electrode of the pass element, and an output terminal coupled to the first current electrode of the pass element; and
an amplifier having a non-inverting input for receiving a reference voltage, an inverting input coupled to the second current electrode of the pass element, and an output coupled to the control electrode of the pass element.

8. The power supply system of claim 7, wherein the second rectifier comprises a PN junction diode.

9. The power supply system of claim 8, wherein:
the pass element comprises a metal-oxide-semiconductor (MOS) transistor;
the second current electrode of the pass element is coupled to a body thereof; and
the PN junction diode is a parasitic diode between the body and first current electrode of the MOS transistor.

10. The power supply system of claim 7, wherein the pass element and the load are combined on a single integrated circuit.

11. The power supply system of claim 7, wherein the inverting input of the amplifier is coupled to the second current electrode of the pass element through a resistor divider.

12. The power supply system of claim 7, further comprising a regulator coupled between the output terminal of the first rectifier and the load.

13. The power supply system of claim 12, wherein the regulator comprises:
a second pass element having a first current electrode coupled to the output terminal of the first rectifier, a control electrode, and a second current electrode coupled to a power supply terminal of the load;
a second amplifier having a non-inverting input for receiving the reference voltage, and inverting input, and an output coupled to the control electrode of the second pass element; and
a second voltage divider for providing a predetermined fraction of a voltage at the power supply terminal of the load to the inverting input of the second amplifier.

14. The power supply system of claim 12, further comprising one or more of the capacitor voltage limiter, the regulator, and the load configured in one of a first configuration, a second configuration, and a third configuration, wherein:
the first configuration comprises the capacitor voltage limiter and the regulator combined on a single integrated circuit;
the second configuration comprises the capacitor voltage limiter, the regulator and the load combined on the single integrated circuit; and
the third configuration comprises the capacitor voltage limiter and the regulator combined to function as the load.

15. A method for supplying voltage at a supply node, comprising:
receiving a rectified voltage at a supply node;
forming a portion of a voltage at a first terminal of a capacitor;
comparing the portion to a reference voltage;
charging the capacitor from the supply node in response to the comparing, wherein the comparing causes the charging when the portion is less than the reference voltage; and
powering a load coupled to the supply node using the capacitor through a rectifier having an input coupled to the capacitor and an output coupled to the supply node when a voltage at the supply node falls below the voltage at the first terminal of the capacitor by more than a predetermined voltage.

16. The method of claim 15, further comprising:
coupling a second terminal of the capacitor to a reference voltage terminal.

17. The method of claim 15, wherein receiving the rectified voltage at the supply node comprises:
receiving an input voltage at an input of a first rectifier; and
rectifying the input voltage to provide the input voltage, so rectified, to the supply node.

18. The method of claim 15, wherein conducting the first current from the supply node to the first terminal of the capacitor comprises:
modulating a conductivity of a transistor until the portion is substantially equal to the reference voltage.

19. The method of claim 18, wherein conducting the second current from the first terminal of the capacitor to the supply node comprises:
forming a diode between the first terminal of the capacitor and the supply node.

20. The method of claim 19, wherein forming the diode between the first terminal of the capacitor and the supply node comprises:
forming the transistor as a metal-oxide-semiconductor (MOS) transistor having a first current electrode coupled to the supply node and a second current electrode coupled to the first terminal of the capacitor; and
coupling the second current electrode of the transistor to a body thereof, thereby forming a parasitic diode.
